(19) United States
(12) Patent Application Publication
(10) Pub. No.: US 2015/0172570 A1
(43) Pub. Date: Jun. 18, 2015

(54) IMAGE SENSOR CAPABLE OF ADJUSTING NUMBER OF OVERSAMPLINGS, METHOD OF OPERATING THE SAME, AND IMAGE DATA PROCESSING SYSTEM INCLUDING THE SAME

(71) Applicant: SAMSUNG ELECTRONICS CO., LTD., Suwon-si (KR)

(72) Inventors: Hirosige GOTO, Suwon-si (KR); Young Gu JIN, Osan-si (KR); Tae Chan KIM, Yongin-si (KR); Dong Ki MIN, Seoul (KR)

(73) Assignee: SAMSUNG ELECTRONICS CO., LTD., Suwon-si (KR)

(21) Appl. No.: 14/568,273

(22) Filed: Dec. 12, 2014

(30) Foreign Application Priority Data
Dec. 12, 2013 (KR) 10-2013-0154762

(51) Int. Cl. H04N 5/353; H04N 5/378

(52) U.S. Cl. CPC H04N 5/353; H04N 5/378

(57) ABSTRACT

A method of operating an image sensor is provided. The method includes detecting a signal related to brightness of an object and generating a control signal which corresponds to a result of the detected signal and adjusting an oversampling number within a range of a single frame time based on the control signal.

### CROSS-REFERENCE TO RELATED APPLICATIONS

This application claims priority from Korean Patent Application No. 10-2013-0154762 filed on Dec. 12, 2013, the disclosure of which is hereby incorporated by reference in its entirety.

### BACKGROUND

Exemplary embodiments of the inventive concept relate to an image sensor capable of adjusting the number of oversamplings. In particular, exemplary embodiments relate to an image sensor capable of adjusting the number of oversamplings according to illumination, a method of operating the image sensor capable of adjusting the number of oversamplings according to illumination, and an image data processing system including the image sensor capable of adjusting the number of oversamplings according to illumination.

Image sensors in the related art are used to convert a received optical image into electrical signals in digital photography. Image sensors in the related art are divided into charged coupled devices (CCD) image sensors and complementary metal-oxide-semiconductor (CMOS) image sensors. A CMOS image sensor (or a CMOS image sensor chip) is an active pixel sensor manufactured using CMOS processes. The CMOS image sensor chip includes a pixel array that includes a plurality of pixels.

Each of the pixels includes a photoelectric conversion element that converts an optical signal into an electrical signal and an additional circuit, i.e., a readout circuit that converts the electrical signal into digital data. A photodiode is used to generate charges (or electrons) based on the intensity of light during an integration time, i.e., a time interval while light is being received and store the generated charges.

Such storage capacity has been known as full-well capacity, which is very important to a dynamic range. The full-well capacity may be defined as the amount of charges that can be maintained before an individual pixel is saturated.

The charges are transferred to a floating diffusion node via a transfer transistor. The charges in the floating diffusion node are converted into a voltage, e.g., a readout signal. The photodiode generates the charges in proportion to illumination. When the CMOS image sensor chip (e.g., the photodiode) is exposed at a white level (or high illumination), as charges are excessively generated in the photoelectric conversion element, that is, individual pixels are saturated, the CMOS image sensor chip may not be able to normally convert an optical image into electrical signals.

### SUMMARY

According to an aspect of an exemplary embodiments, there is provided a method of operating an image sensor. The method includes detecting, by a determination logic circuit, a signal related to brightness of an object and generating a control signal which corresponds to a result of the detected signal and adjusting, by a controller, an oversampling number within a range of a single frame time based on the control signal. The signal related to the brightness of the object may be a signal which corresponds to part of an image of the object which is sensed by a pixel array included in the image sensor.

The oversampling number may be determined based on a ratio of a saturation level of the image sensor to a level of the detected signal, and the oversampling number may include an integer greater than 1.

The generating the control signal may include decreasing a first integration time to a second integration time in response to the level of the detected signal during the first integration time being equal to or higher than the saturation level of the image sensor.

Alternatively, the detected signal related to the brightness of the object may be an illumination signal output from an illuminance sensor which is included in the image sensor. At this time, the adjusting the oversampling number may include determining, by the determination logic circuit, an integration time based on the illumination signal and determining, by the determination logic circuit, the oversampling number based on a ratio of the single frame time to the integration time. The oversampling number may include an integer greater than 1.

The method may further include performing photoelectric conversion using a photoelectric conversion element during an integration time when oversampling is performed, converting a plurality of charges generated by the photoelectric conversion element to a plurality of digital signals during a readout time when the oversampling is performed, and accumulating the digital signals in a memory such that full-frame image data is obtained.

The adjusting the oversampling number may include adjusting a full-well capacity of a photoelectric conversion element which is included in the image sensor.

According to an aspect of the exemplary embodiments, there is provided an image sensor including a pixel array which includes a plurality of pixels, a row driver configured to drive the pixels in units of rows, a readout circuit configured to read out a plurality of pixel signals output from the pixels, a determination logic circuit configured to detect a signal related to brightness of an object and generate a control signal which corresponds to a result of the detected signal, and a timing controller configured to control the row driver to adjust an oversampling number within a range of a single frame time based on the control signal.

According to an aspect of the exemplary embodiments, there is provided an image data processing system including a display, an image sensor, and a processor configured to control the display and the image sensor. The image sensor includes a pixel array including a plurality of pixels, a row driver configured to drive the pixels in units of rows, a readout circuit configured to read out a plurality of pixel signals output from the pixels, a determination logic circuit configured to detect a signal related to brightness of an object and generate a control signal which corresponds to a result of the detected signal, and a timing controller configured to control the row driver to adjust an oversampling number within a range of a single frame time based on the control signal

The processor may be further configured to transmit the detected signal related to the brightness of the object to the image sensor based on a user input which is input on a user interface through the display. The display may include a touch screen panel which is configured to process the user input. The processor may be further configured to transmit the detected signal related to the brightness of the object to the image sensor based on selected information about a reference region in an image displayed on the display.

According to an aspect of the exemplary embodiments, there is provided an image sensor including an illumination sensor configured to sense an ambient illumination of an object and output an illumination signal which corresponds to a result of the detected signal, a determination circuit configured to detect the illumination signal related to brightness of the object and generate a control signal which corresponds to a result of the detected illumination signal, and a timing controller configured to generate a plurality of adjustment signals for adjusting an oversampling number within a range of a single frame time in response to the control signal.

### BRIEF DESCRIPTION OF THE DRAWINGS

The above and other features and advantages of the inventive concept will become more apparent by describing in detail exemplary embodiments thereof with reference to the attached drawings in which:

FIG. 1 is a schematic block diagram of an image sensor according to exemplary embodiments of the inventive concept;

FIG. 2 is a timing diagram of output signals of a readout circuit with respect to brightness or integration time;

FIG. 3 is a flowchart of a method of operating the image sensor illustrated in FIG. 1 according to exemplary embodiments of the inventive concept;

FIG. 4 is a diagram illustrating cases of the number of integrations changing according to illumination according to exemplary embodiments of the inventive concept;

FIG. 5 is a schematic block diagram of an image sensor according to exemplary embodiments of the inventive concept;

FIG. 6 is a flowchart of a method of operating the image sensor illustrated in FIG. 5 according to exemplary embodiments of the inventive concept;

FIG. 7 is a diagram of examples of a reference region selected by a user according to exemplary embodiments of the inventive concept;

FIG. 8 is a flowchart of a method of adjusting the number of integrations according to a reference region selected by a user according to exemplary embodiments of the inventive concept; and

FIG. 9 is a block diagram of a computing system including the image sensor illustrated in FIG. 1 or 5 according to exemplary embodiments of the inventive concept.

### DETAILED DESCRIPTION OF THE EXEMPLARY EMBODIMENTS

The inventive concept now will be described more fully hereinafter with reference to the accompanying drawings, in which exemplary embodiments are shown. This exemplary embodiments may, however, be embodied in many different forms and should not be construed as limited to the embodiments set forth herein. Rather, these embodiments are provided so that this disclosure will be thorough and complete, and will fully convey the scope of the exemplary embodiments to those skilled in the art. In the drawings, the size and relative sizes of layers and regions may be exaggerated for clarity. Like numbers refer to like elements throughout.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. As used herein, the term “and/or” includes any and all combinations of one or more of the associated listed items and may be abbreviated as “/”.

It will be understood that, although the terms first, second, etc., may be used herein to describe various elements, these elements should not be limited by these terms. These terms are only used to distinguish one element from another. For example, a first signal could be termed a second signal, and, similarly, a second signal could be termed a first signal without departing from the teachings of the disclosure.

The terminology used herein is for the purpose of describing particular exemplary embodiments only and is not intended to be limiting of the exemplary embodiments. As used herein, the singular forms “a”, “an” and “the” are intended to include the plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Unless otherwise defined, all terms (including technical and scientific terms) used herein have the same meaning as commonly understood by one of ordinary skill in the art to which these exemplary embodiments belong. It will be further understood that terms, such as those defined in commonly used dictionaries, should be interpreted as having a meaning that is consistent with their meaning in the context of the relevant art and/or the present application, and will not be interpreted in an idealized or overly formal sense unless expressly so defined herein.

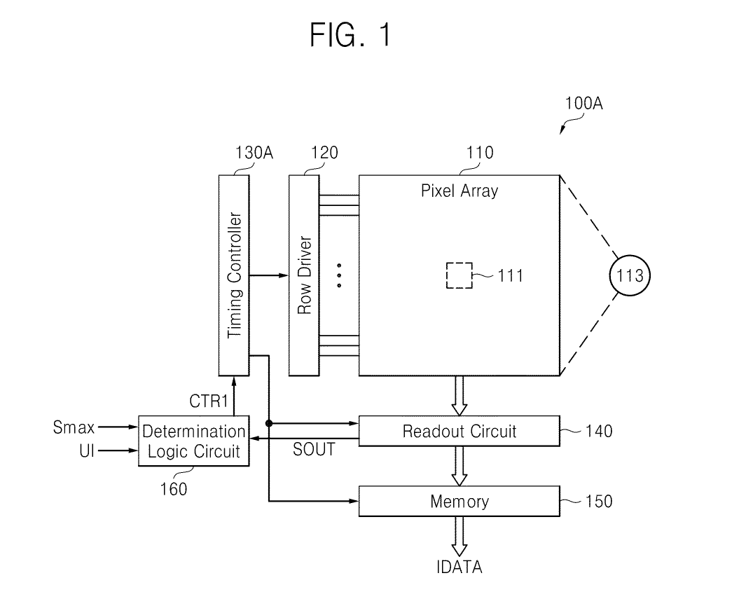

FIG. 1 is a schematic block diagram of an image sensor 100A according to exemplary embodiments of the inventive concept. The image sensor 100A may include a pixel array 110, a row driver 120, a timing controller 130A, a readout circuit 140, a memory 150, and a determination logic circuit 160.

The pixel array 110 includes a plurality of pixels in a two dimensional matrix. Each of the pixels may include a photodiode and M transistors, where M is 3, 4, or 5.

The row driver 120 may drive the pixels in units of rows. The timing controller 130A may generate adjustment signals for adjusting the number of oversamplings, i.e., an oversampling number in response to a control signal CTR1 and transmit the adjustment signals to the row driver 120. Consequently, the row driver 120 may control the operation of the pixels in units of rows in response to the adjustment signals.

Oversampling (i.e., sampling or multiple sampling) may include an integration operation and a readout operation. For instance, the integration operation performed during an integration time includes generating charges using a photoelectric conversion element (e.g., a photodiode, a photo gate, a photo transistor, or a pinned photodiode) included in a pixel and storing the charges. The readout operation includes transmitting charges integrated at the photoelectric conversion element to a floating diffusion node using a transfer transistor, generating a pixel signal based on the charges, and generating a digital pixel signal from the pixel signal using the readout circuit 140.

The readout circuit 140 may convert pixel signals output from the pixel array 110 into digital pixel signals according to the control of the timing controller 130A. The readout circuit 140 may generate a signal, i.e., a first brightness signal SOUT related to the illumination or brightness of an object 113. The first brightness signal SOUT of the object 113 may be a digital signal or digital signals.

According to the control of the timing controller 130A, the memory 150 may output full-frame image data IDATA corresponding to the digital pixel signals.

The pixel array 110 includes partial pixels 111 that generate pixel signals defining the first brightness signal SOUT of the object 113. A method of defining the number and positions of the partial pixels 111 may vary with the design of the image sensor 100A. In some embodiments, all pixels in the pixel array 110 may be defined as the partial pixels 111. In other embodiments, the number and positions of the partial pixels 111 may be freely changed by a user setting.

The determination logic circuit 160 may detect (or analyze) the first brightness signal SOUT of the object 113 and generate the control signal CTR1 corresponding to the detection (or analysis) result. As described above, the control signal CTR1 may function as a control signal (or control signals) for adjusting an oversampling number (i.e., the number of integrations or a full-well capacity) within a range of a single frame time.

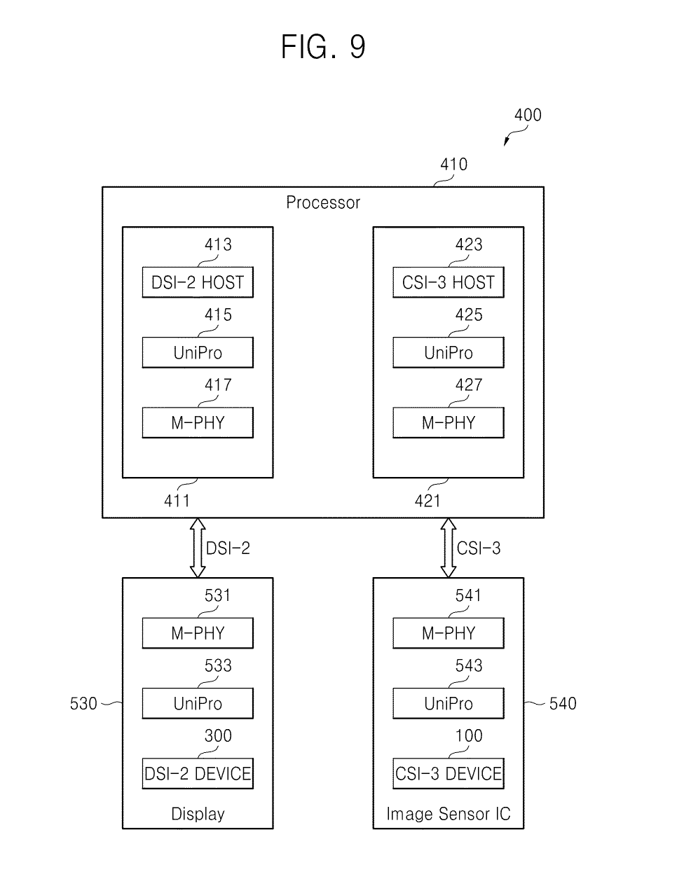

The determination logic circuit 160 may generate the control signal CTR1 in response to an oversampling adjustment signal UI output from a processor (e.g., processor 410 in FIG. 9) that controls the operations of the image sensor 100A. The oversampling adjustment signal UI may be a signal (or signals) related to a user input.

The determination logic circuit 160 may determine which either the first brightness signal SOUT or the oversampling adjustment signal UI will be processed first based on priority information. For example, the priority information may be set by a manufacturer or a user and it may be stored in a register of the determination logic circuit 160.

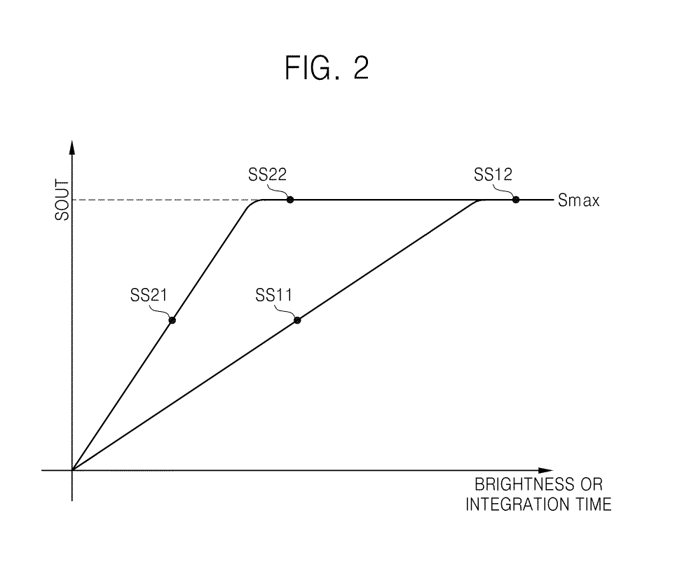

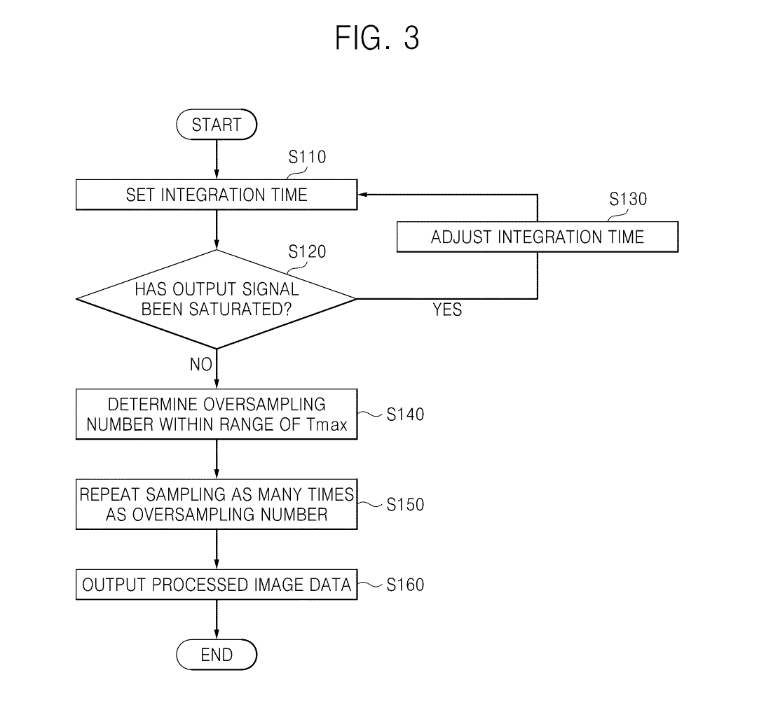

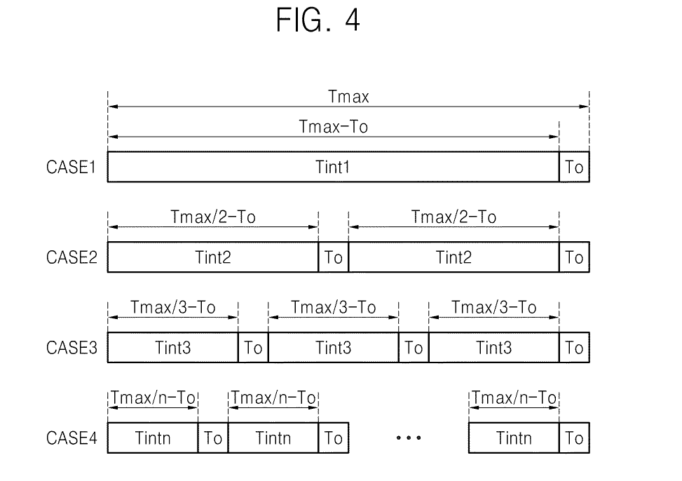

FIG. 2 is a timing diagram of output signals of the readout circuit 140 with respect to brightness or integration time. FIG. 3 is a flowchart of a method of operating the image sensor 100A illustrated in FIG. 3 according to exemplary embodiments of the inventive concept. FIG. 4 is a diagram illustrating cases of the number of integrations changing according to illumination according to exemplary embodiments of the inventive concept. A method of adjusting an oversampling number or a full-well capacity will be described in detail with reference to FIGS. 1 through 4.

For descriptive convenience, it is assumed that a second integration time Tint2 in CASE2 is set as an integration time in operation S110. Accordingly, the image sensor 100A detects the first brightness signal SOUT of the object 113 using the second integration time Tint2 according to the adjustment signals of the timing controller 130A in operation S120.

When the first brightness signal SOUT output from the readout circuit 140 is SS11, that is, when the first brightness signal SOUT has not been saturated, the determination logic circuit 160 may determine the oversampling number within a range of a single frame time Tmax. For example, the single frame time Tmax may be determined by a frame rate.

The determination logic circuit 160 may externally receive information about a saturation level Smax and information about the single frame time Tmax, and may store the information in an internal register. For example, the information about the saturation level Smax and the information about the single frame time Tmax may be updated.

For instance, the determination logic circuit 160 may determine the oversampling number based on a ratio of the saturation level Smax to the level SS11 of the first brightness signal SOUT, i.e., Smax/SS11, and may output the control signal CTR1 corresponding to the oversampling number to the timing controller 130A. The oversampling number may be an integer greater than 1.

According to the ratio calculated by the determination logic circuit 160, the oversampling number may increase to 3 or “n” (where “n” is an integer greater than 3) as shown in CASE3 or CASE4 in FIG. 4, or may decrease to 1 as shown in CASE1 in FIG. 4.

The image sensor 100A repeats sampling as many times as the determined oversampling number in operation S150. In other words, the image sensor 100A performs photoelectric conversion using a photoelectric conversion element in each integration time Tint3 or Tintn, and converts charges generated in the photoelectric conversion element into digital signals using the readout circuit 140 in each readout time To.

In order to obtain the full-frame image data IDATA, digital signals generated each time oversampling is performed are accumulated in the memory 150. The memory 150 outputs the full-frame image data IDATA generated through the accumulation during the oversampling. The oversampling is repeated as many times as the oversampling number in operation S160.

However, when the first brightness signal SOUT is SS12, that is, when the first brightness signal SOUT has been saturated, the determination logic circuit 160 resets the integration time of the image sensor 100A to a third integration time Tint3 less than the second integration time Tint2. According to embodiments, the determination logic circuit 160 may reset the integration time of the image sensor 100A to a time less than the third integration time Tint3.

Accordingly, the image sensor 100A detects the first brightness signal SOUT of the object 113 using the third integration time Tint3 according to the adjustment signals of the timing controller 130A in operation S120 and then the image sensor 100A may perform operations S130, S140, S150, and S160.

Further, it is assumed that a first integration time Tint1 is set as the integration time as shown in CASE1 in operation S110. The image sensor 100A detects the first brightness signal SOUT of the object 113 using the first integration time Tint1 according to the adjustment signals of the timing controller 130A in operation S120.

When the first brightness signal SOUT output from the readout circuit 140 is SS21, that is, when the first brightness signal SOUT has not been saturated, the determination logic circuit 160 may determine the oversampling number within a range of the single frame time Tmax.

The determination logic circuit 160 may determine the oversampling number based on a ratio of the saturation level Smax to the level SS21 of the first brightness signal SOUT, i.e., Smax/SS21 and may output the control signal CTR1 corresponding to the oversampling number to the timing controller 130A. The oversampling number may be an integer greater than 1. According to the ratio calculated by the determination logic circuit 160, the oversampling number may increase to 2, 3, or “n” (where “n” is an integer greater than 3) as shown in CASE2, CASE3, or CASE4 in FIG. 4.

The image sensor 100A repeats sampling as many times as the determined oversampling number in operation S150. In other words, the image sensor 100A performs photoelectric conversion using the photoelectric conversion element in each integration time Tint2, Tint3, or Tintn and converts charges generated in the photoelectric conversion element into digital signals using the readout circuit 140 in each readout time To.

In order to obtain the full-frame image data IDATA, digital signals generated each time oversampling is performed are accumulated in the memory 150. The memory 150 outputs the full-frame image data IDATA generated through the accumulation during the oversampling repeated as many times as the oversampling number in operation S160.

However, when the first brightness signal SOUT is SS22, that is, when the first brightness signal SOUT has been saturated, the determination logic circuit 160 resets the integration time of the image sensor 100A to the second integration time Tint2 less than the first integration time Tint1. According to exemplary embodiments, the determination logic circuit 160 may reset the integration time of the image sensor 100A to a time less than the second integration time Tint2.

The image sensor 100A detects the first brightness signal SOUT of the object 113 using the second integration time Tint2 according to the adjustment signals of the timing controller 130A in operation S120, and then the image sensor 100A may perform operations S130, S140, S150, and S160.

As shown in FIG. 4, the sampling number during the single frame time Tmax is 1 in CASE1, 2 in CASE2, 3 in CASE3, and “n” in CASE4.

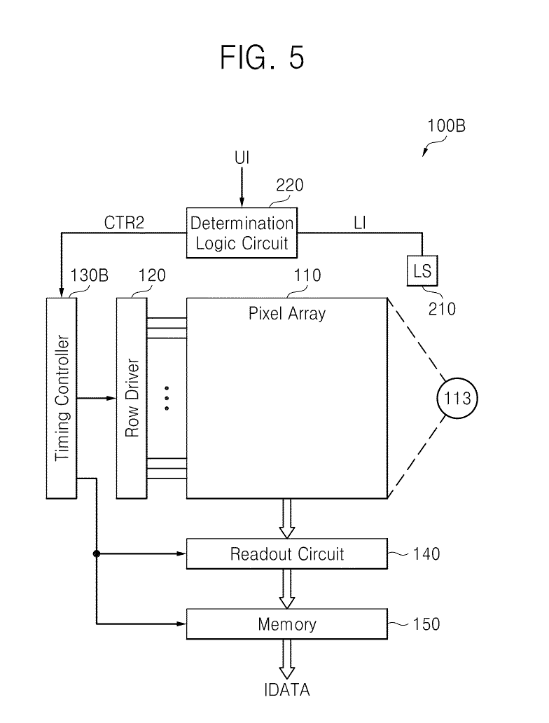

FIG. 5 is a schematic block diagram of an image sensor 100B according to exemplary embodiments of the inventive concept. Referring to FIG. 5, the image sensor 100B may include the pixel array 110, the row driver 120, a timing controller 130B, the readout circuit 140, the memory 150, an illuminance sensor (LS) 210, and a determination logic circuit 220.

The LS 210 senses an ambient illumination of the image sensor 110B or the object 113 and outputs an illumination signal LI which corresponds to the sensing result to the determination logic circuit 220. The determination logic circuit 220 detects a signal related to the brightness of the object 113, i.e., the illumination signal LI (hereinafter, referred to a second brightness signal LI) and outputs a control signal CTR2 corresponding to the detection result. The timing controller 130B may generate adjustment signals for adjusting an oversampling number in response to the control signal CTR2 and transmit the adjustment signals to the row driver 120.

The determination logic circuit 220 may generate the control signal CTR2 in response to the oversampling adjustment signal UI output from a processor (e.g., processor 410 in FIG. 9) that controls the operations of the image sensor 100B. The determination logic circuit 220 may determine which of the second brightness signal LI or the oversampling adjustment signal UI will be processed first based on priority information. The priority information may be set by a user and it may be stored in a register of the determination logic circuit 220.

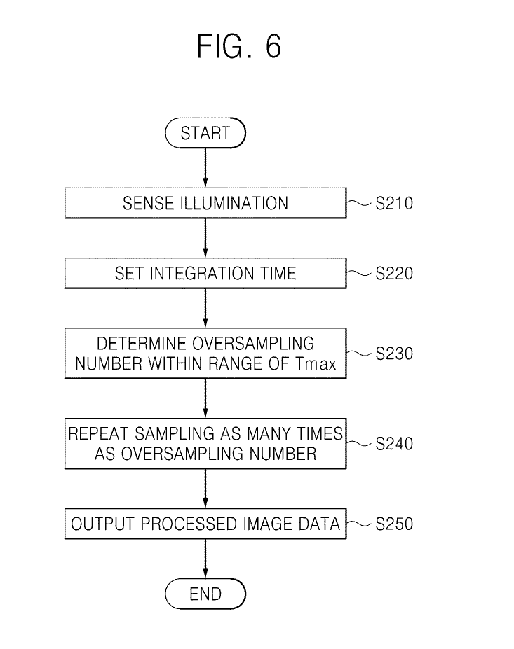

FIG. 6 is a flowchart of a method of operating the image sensor 100B illustrated in FIG. 5 according to exemplary embodiments of the inventive concept. A method of adjusting an oversampling number will be described in detail with reference to FIGS. 2, 4, 5, and 6.

The LS 210 senses an ambient illumination of the image sensor 100B or the object 113 and outputs the illumination signal, i.e., second brightness signal LI of the object 113 to the determination logic circuit 220 in operation S210.

The determination logic circuit 220 sets an integration time in operation S220. For instance, the determination logic circuit 220 may determine an integration time T using a maximum illumination signal Imax, the illumination signal LI, and a minimum frame time Tmin in operation S220. For instance, the integration time T may be defined as Tmin*LI/Imax.

The determination logic circuit 220 determines the oversampling number based on a ratio of the integration time T to the single frame time Tmax, i.e., Tmax/T, and outputs the control signal CTR2 corresponding to the oversampling number to the timing controller 130B. The oversampling number may be an integer greater than 1.

The illumination signal LI output from the LS 210 is nearly proportional to the output signal SOUT of the readout circuit 140. Therefore, CASE1, CASE2, CASE3, and CASE4 in FIG. 4 can be applied to the image sensor 100B illustrated in FIG. 5.

When the determination logic circuit 220 sets the second integration time Tint2 as the integration time T in operation S230, the image sensor 100B repeats oversampling two times in operation S240. In other words, the image sensor 100B performs photoelectric conversion using a photoelectric conversion element in each integration time Tint2 and converts charges generated in the photoelectric conversion element into digital signals using the readout circuit 140 in each readout time To.

In order to obtain the full-frame image data IDATA, digital signals generated each time oversampling is performed are accumulated in the memory 150. The memory 150 outputs the full-frame image data IDATA generated through the accumulation during two times of oversampling in operation S250.

However, when the determination logic circuit 220 sets the third integration time Tint3 as the integration time T in operation S230, the image sensor 100B repeats oversampling three times in operation S240. In other words, the image sensor 100B performs photoelectric conversion using the photoelectric conversion element in each integration time Tint3, and converts charges generated in the photoelectric conversion element into digital signals using the readout circuit 140 in each readout time To.

In order to obtain the full-frame image data IDATA, digital signals generated each time oversampling is performed are accumulated in the memory 150. The memory 150 outputs the full-frame image data IDATA generated through the accumulation during three times of oversampling in operation S250.

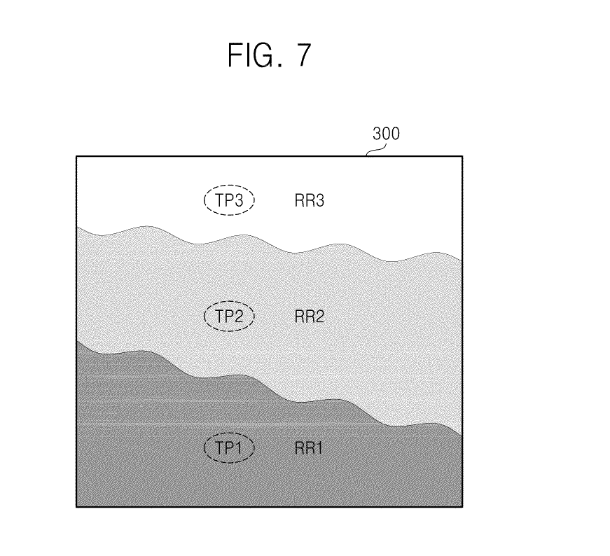

FIG. 7 is a diagram of examples of a reference region selected by a user according to exemplary embodiments of the inventive concept. An image displayed on a display 300 illustrated in FIG. 7 has a different brightness in each of the reference regions. For instance, a first reference region RR1 is darkest, a third reference region RR3 is brightest, and a second reference region RR2 has a medium brightness.

The user may select one of the reference regions RR1, RR2, and RR3 on the display 300 including a touch screen panel. For instance, when the user selects the first reference region RR1 through a first touch input TP1, an oversampling number is the smallest value. When the user selects the third reference region RR3 through a third touch input TP3, the oversampling number is the largest value. When the user selects the second reference region RR2 through a second touch input TP2, the oversampling number is the middle value between the oversampling number of the first reference region and the oversampling number of the third reference region.

Each of the user inputs TP1, TP2, and TP3 is related to the oversampling adjustment signal UI. In some cases, each of the user inputs TP1, TP2, and TP3 may be touch points of a user interface.

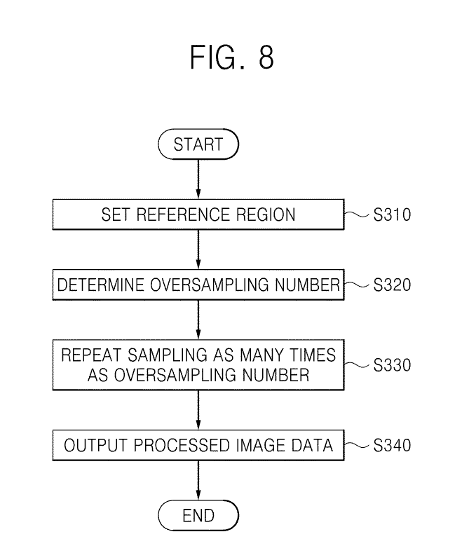

FIG. 8 is a flowchart of a method of adjusting the number of integrations according to a reference region selected by a user according to exemplary embodiments of the inventive concept. Referring to FIGS. 1, 5, 7, and 8, when the user inputs the first touch input TP1, the oversampling adjustment signal UI which corresponds to the first touch input TP1 is input to the determination logic circuit 160 or 220 in operation S310.

The determination logic circuit 160 or 220 analyzes the oversampling adjustment signal UI and determines an oversampling number according to the analysis result in operation S320. The control signal CTR1 or CTR2 indicating the oversampling number is output to the timing controller 130A or 130B.

When the determination logic circuit 160 or 220 outputs the control signal CTR1 or CTR2 indicating an oversampling number of 1 to the timing controller 130A or 130B, the image sensor 100A or 100B performs sampling once, as shown in CASE1 in FIG. 4, in operation S330 and stores digital pixel signals corresponding to the sampling result in the memory 150. The full-frame image data IDATA corresponding to the pixel signals stored in the memory 150 is output according to the control of the timing controller 130A or 130B in operation S340.

Referring to FIGS. 1, 5, 7, and 8, when the user inputs the second touch input TP2, the oversampling adjustment signal UI corresponding to the second touch input TP2 is input to the determination logic circuit 160 or 220 in operation S310.

The determination logic circuit 160 or 220 analyzes the oversampling adjustment signal UI and determines an oversampling number according to the analysis result in operation S320. The control signal CTR1 or CTR2 indicating the oversampling number is output to the timing controller 130A or 130B.

When the determination logic circuit 160 or 220 outputs the control signal CTR1 or CTR2 indicating an oversampling number of 3 to the timing controller 130A or 130B, the image sensor 100A or 100B performs sampling three times, as shown in CASE3 in FIG. 4, in operation S330 and accumulates digital pixel signals corresponding to the sampling result in the memory 150. The full-frame image data IDATA corresponding to the pixel signals accumulated in the memory 150 is output according to the control of the timing controller 130A or 130B in operation S340.

Referring to FIGS. 1, 5, 7, and 8, when the user inputs the third touch input TP3, the oversampling adjustment signal UI corresponding to the third touch input TP3 is input to the determination logic circuit 160 or 220 in operation S310.

The determination logic circuit 160 or 220 analyzes the oversampling adjustment signal UI and determines an oversampling number according to the analysis result in operation S320. The control signal CTR1 or CTR2 indicating the oversampling number is output to the timing controller 130A or 130B.

When the determination logic circuit 160 or 220 outputs the control signal CTR1 or CTR2 indicating an oversampling number of “n” to the timing controller 130A or 130B, the image sensor 100A or 100B performs sampling “n” times, as shown in CASE4 in FIG. 4, in operation S330 and accumulates digital pixel signals corresponding to the sampling result in the memory 150. The full-frame image data IDATA corresponding to the pixel signals accumulated in the memory 150 is output according to the control of the timing controller 130A or 130B in operation S340.

FIG. 9 is a block diagram of a computing system 400 including the image sensor 100A illustrated in FIG. 1 or the image sensor 100B illustrated in FIG. 5 according to exemplary embodiments of the inventive concept. Referring to FIGS. 1 through 9, the computing system 400 includes a processor 410, a display 530, and an image sensor integrated circuit (IC) 540. The computing system 400 may be implemented as a mobile telephone, a smart phone, a tablet personal computer (PC), a mobile internet device (MID), or wearable computer.

The processor 410 may control the display 530 and the image sensor IC 540. The processor 410 may be implemented as an IC, a system on chip (SoC), an application processor (AP), or a mobile AP. The processor 410 includes a display host 411 that communicates with the display 530 and an image sensor IC host 421 that communicates with the image sensor IC 540.

The display host 411 includes a display serial interface (DSI)-2 host 413, a UniPro 415, and an M-PHY 417. The image sensor IC host 421 includes a camera serial interface (CSI)-3 host 423, a UniPro 425, and an M-PHY 427.

The display host 411 may communicate data with the display 530 using DSI-2. The display 530 includes an M-PHY 531, a UniPro 533, and a DSI-2 device 300. The DSI-2 device 300 may include a display panel or both a touch screen panel and a display panel.

According to the control of the processor 410, the DSI-2 device 300 may provide a user interface that can receive the touch inputs TP1, TP2, and TP3 or a user menu that can control the operation of the image sensor IC 540 for the user.

The image sensor IC host 421 may communicate data with the image sensor IC 540 using CSI-3. The image sensor IC 540 includes an M-PHY 541, a UniPro 543, and a CSI-3 device 100. The CSI-3 device 100 may be the image sensor 100A illustrated in FIG. 1 or the image sensor 100B illustrated in FIG. 5.

As described above, according to exemplary embodiments of the inventive concept, an image sensor converts an optical image into electrical signals regardless of illumination and adjusts an oversampling number or a full-well capacity according to the illumination, thereby optimizing a signal-to-nose ratio (SNR) in a high dynamic range (HDR) or wide dynamic range (WDR).

While the inventive concept has been particularly shown and described with reference to exemplary embodiments thereof, it will be understood by those of ordinary skill in the art that various changes in forms and details may be made therein without departing from the spirit and scope of the inventive concept as defined by the following claims.

1. A method of operating an image sensor, the method comprising:
detecting, by a determination logic circuit, a signal related to brightness of an object and generating a control signal which corresponds to a result of the detected signal; and
adjusting, by a timing controller, an oversampling number within a range of a single frame time based on the control signal.

2. The method of claim 1, wherein the signal related to the brightness of the object is a signal which corresponds to part of an image of the object which is sensed by a pixel array included in the image sensor.

3. The method of claim 2, wherein the oversampling number is determined based on a ratio of a saturation level of the image sensor to a level of the detected signal, and wherein the oversampling number comprises an integer greater than 1.

4. The method of claim 3, wherein the generating the control signal comprises decreasing a first integration time to a second integration time in response to the level of the detected signal during the first integration time being equal to or higher than the saturation level of the image sensor.

5. The method of claim 1, wherein the detected signal related to the brightness of the object is an illumination signal output from an illuminance sensor which is included in the image sensor.

6. The method of claim 5, wherein the adjusting the oversampling number comprises:
determining, by the determination logic circuit, an integration time based on the illumination signal; and
determining, by the determination logic circuit, the oversampling number based on a ratio of the single frame time to the integration time,
wherein the oversampling number comprises an integer greater than 1.

7. The method of claim 1, further comprising:
performing photoelectric conversion using a photoelectric conversion element during an integration time when oversampling is performed;
converting a plurality of charges generated by the photoelectric conversion element to a plurality of digital signals during a readout time when the oversampling is performed; and
accumulating the digital signals in a memory such that full-frame image data is obtained.

8. The method of claim 1, wherein the adjusting the oversampling number comprises adjusting a full-well capacity of a photoelectric conversion element which is included in the image sensor.

9. An image sensor comprising:
a pixel array which comprises a plurality of pixels;
a row driver configured to drive the pixels in units of rows;
a readout circuit configured to read out a plurality of pixel signals output from the pixels;
a determination logic circuit configured to detect a signal related to brightness of an object and generate a control signal which corresponds to a result of the detected signal; and
a timing controller configured to control the row driver to adjust an oversampling number within a range of a single frame time based on the control signal.

10. The image sensor of claim 9, wherein the detected signal related to the brightness of the object corresponds to the pixel signals output from some of the pixels.

11. The image sensor of claim 10, wherein the determination logic circuit is configured to generate the control signal based on a ratio of a saturation level of the pixels to a level of the pixel signals output from some of the pixels.

12. The image sensor of claim 11, wherein the determination logic circuit is further configured to decrease a first integration time to a second integration time to generate the control signal in response to the level of the detected signal during the first integration time being equal to or higher than the saturation level of the pixels.

13. The image sensor of claim 9, further comprising:
an illuminance sensor configured to sense an ambient illumination of the object and output the detected signal related to the brightness of the object which corresponds to a result of the sensed ambient illumination.

14. The image sensor of claim 13, wherein the determination logic circuit is further configured to determine an integration time based on the detected signal output from the illuminance sensor and generate the control signal based on a ratio of the single frame time to the integration time,
wherein the oversampling number comprises an integer greater than 1.

15. The image sensor of claim 9, further comprising:
a memory,
wherein when oversampling is performed, a photoelectric conversion element included in the pixels is configured to perform photoelectric conversion during an integration time and the readout circuit is further configured to convert a plurality of charges generated by the photoelectric conversion element to a plurality of digital signals during a readout time; and
wherein the memory is configured to accumulate the digital signals such that full-frame image data is obtained.

16. An image data processing system comprising:
a display;
an image sensor; and
a processor configured to control the display and the image sensor,
wherein the image sensor comprises:
a pixel array including a plurality of pixels;
a row driver configured to drive the pixels in units of rows;
a readout circuit configured to read out a plurality of pixel signals output from the pixels;
a determination logic circuit configured to detect a signal related to brightness of an object and generate a control signal which corresponds to a result of the detected signal; and
a timing controller configured to control the row driver to adjust an oversampling number within a range of a single frame time based on the control signal.

17. The image data processing system of claim 16, wherein the processor is further configured to transmit the detected signal related to the brightness of the object to the image sensor based on a user input which is input on a user interface through the display.

18. The image data processing system of claim 17, wherein the display comprises a touch screen panel which is configured to process the user input.

19. The image data processing system of claim 16, wherein the processor is further configured to transmit the detected signal related to the brightness of the object to the image sensor based on selected information about a reference region in an image displayed on the display.

20. The image data processing system of claim 16, wherein the detected signal related to the brightness of the object corresponds to the pixel signals output from some of the pixels.

21. The image data processing system of claim 16, further comprising:
an illuminance sensor configured to sense an ambient illumination of the object and output the detected signal related to the brightness of the object which corresponds to a result of the sensed ambient illumination.

22.-25. (canceled)
